(19) United States
(12) Patent Application Publication
(10) Pub. No.: US 2010/0096447 A1
(43) Pub. Date: Apr. 22, 2010

(54) OPTICAL IDENTIFICATION TAG, READER AND SYSTEM

(76) Inventors: Sunghoon Kwon, Seoul (KR); Youngjune Park, Seoul (KR); Suhwan Kim, Seoul (KR)

Correspondence Address: SHERR & VAUGHN, PLLC, 620 HERNDON PARKWAY, SUITE 320, HERNDON, VA, 20170, US

(21) Appl. No.: 12/530,367

(22) PCT Filed: Mar. 7, 2008
(86) PCT No.: PCT/KR2008/001315

§ 371 Date: Nov. 30, 2009

(30) Foreign Application Priority Data
Mar. 9, 2007 (KR) 10-2007-0023261

(51) Int. Cl. G06F 17/00; G06K 7/10; G06K 19/07; H04B 10/00

(52) U.S. Cl. 235/375; 235/454; 235/492; 398/182; 398/202; 398/140

(57) ABSTRACT

The present invention relates to an optical identification tag, a reader, and a system, and more particularly, to an optical identification tag which transmits its identification information using energy input in an optical form, and an optical identification system and reader using the optical identification tag. The present invention provides an optical identification tag and an optical identification reader. The optical identification tag includes a solar cell for converting incident light into an electrical energy, a circuit for providing a transmitted electrical signal corresponding to identification information, and a light emitter for providing a transmitted optical signal corresponding to the transmitted electrical signal, and the optical identification reader provides the incident light to the optical identification tag, and receives the transmitted optical signal from the optical identification tag.

### TECHNICAL FIELD

The present invention relates to an optical identification tag, a reader and a system, and more particularly, to an optical identification tag which transmits its identification information using energy input in an optical form, and an optical identification system and reader using the optical identification tag.

### BACKGROUND ART

An identification system according to the related art includes a radio frequency identification (RFID) system. The RFID system is a data recognition system which may read out identification information stored in an RFID tag by a request of an RFID reader, and uses an RF signal for transmitting the identification information. The RFID tags are mainly divided into an active RFID tag using a battery and a passive RFID tag not using a battery. The passive RFID tag does not require the battery and costs less, so that it can be used permanently and is widely employed.

The RFID tag has an identification circuit and an antenna. The identification circuit has a demodulator for demodulating an RF input signal received from the antenna to obtain receiving data, a controller for generating transmission data corresponding to the identification information, and a modulator for modulating the transmission data to an RF transmitted signal and delivering the RF transmitted signal to the antenna. In a case of the passive RFID, the RFID further includes a rectifier for obtaining a DC power source necessary for operations of the identification circuit from the RF received signal.

Such an RFID tag according to the related art does not need to be in contact with an RFID reader for recognizing the identification information, so that it is currently employed in a public transportation card or the like, and is expected to be applied to many applications such as supermarkets, warehouses, factories and so forth.

However, Such an RFID tag has a relatively large area, which thus has a limit to applications. To detail this, the identification circuit of the RFID tag may be manufactured in a very small area enough to be several tens of μm×several tens of μm, however, the RFID antenna must still be manufactured in a large area of several cm×several cm. Accordingly, the size of the RFID tag becomes several cm×several cm. As such, the RFID tag is big, so that the RFID tag cannot be applied to applications which require a very small-sized identification tag.

### DISCLOSURE

### Technical Problem

In order to solve the foregoing and/or other problems, it is an object of the present invention to provide an identification tag which can be manufactured in a very small size, and an identification system and reader using the identification tag.

### Technical Solution

In a first aspect, the invention is directed to an optical identification tag, which includes: a solar cell for converting incident light into electrical energy, the optical identification tag operating using the electrical energy; a circuit for providing a transmitted electrical signal corresponding to identification information; and a light emitter for providing a transmitted optical signal corresponding to the transmitted electrical signal.

In a second aspect, the invention is directed to an optical identification reader, which includes: a light source for providing transmitted light to an optical identification tag; a photodetector for converting received light provided from the optical identification tag into an electrical signal; a signal processor for processing the electrical signal to obtain information corresponding to identification information of the optical identification tag; and an optical system for delivering the transmitted light to the optical identification tag, and delivering the received light to the photodetector.

In a third aspect, the invention is directed to an optical identification system, which includes: an optical identification tag for converting incident first light into an electrical energy, operating using the electrical energy, and outputting second light corresponding to stored identification information; and an optical identification reader for converting the second light into an electrical signal.

### Advantageous Effects

According to the present invention, an existing RFID may be advantageously replaced by an optical identification tag, and an optical identification reader and system used for the optical identification tag of the present invention.

In addition, the optical identification tag, and the optical identification reader and system used for the optical identification tag according to the present invention employ a solar cell and a light emitter instead of antennas which occupy the largest area in the existing RFID tag, so that an area of the identification tag can be significantly reduced.

In addition, the optical identification tag, and the optical identification reader and system used for the optical identification tag according to the present invention convert a baseband signal into an optical signal to transmit and/or receive the signal, so that an RF circuit is not required, which thus leads to a simplified configuration of a circuit used for transceiving the signal.

In addition, the optical identification tag, and the optical identification reader and system used for the optical identification tag according to the present invention may be advantageously applied to applications requiring a very small identification tag (e.g., jewelry and so forth).

### DESCRIPTION OF DRAWINGS

The above and other objects, features and advantages of the present invention will be more apparent from the following detailed description taken in conjunction with the accompanying drawings, in which:

FIG. 1 illustrates an optical identification tag according to a first exemplary embodiment of the present invention;

FIG. 2 illustrates an example of an identification circuit 130 employed in the optical identification tag of FIG. 1;

FIG. 3 illustrates examples of received and transmitted optical powers of the optical identification tag 100 in which the identification circuit 130 of FIG. 2 is employed;

FIG. 4 illustrates another example of the identification circuit 130 employed in the optical identification tag of FIG. 1;

FIG. 5 illustrates examples of received and transmitted optical powers of the optical identification tag 100 in which the identification circuit 130 of FIG. 4 is employed;

FIG. 6 illustrates an optical identification system having the optical identification tag of FIG. 1;

FIG. 7 illustrates an optical identification tag according to a second exemplary embodiment of the present invention;

FIG. 8 illustrates an optical identification system having the optical identification tag 100A of FIG. 7;

FIG. 9 illustrates the optical identification tag 100 of the present invention applied to jewelry; and

FIG. 10 illustrates the optical identification tag 100 of the present invention applied to a biological field.

### MODE FOR INVENTION

The present invention will now be described more fully hereinafter with reference to the accompanying drawings, in which exemplary embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the thickness of layers and regions are exaggerated for clarity. Like numbers refer to like elements throughout the specification.

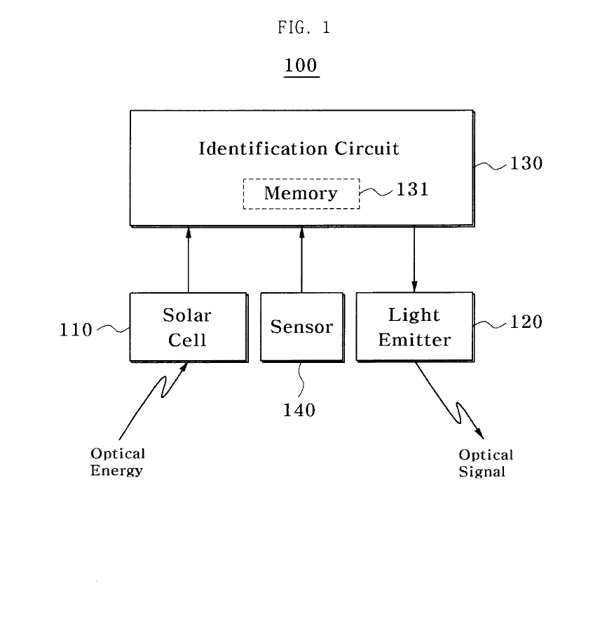

FIG. 1 illustrates an optical identification tag according to a first exemplary embodiment of the present invention. Referring to FIG. 1, an optical identification tag 100 includes a solar cell 110, a light emitter 120, and an identification circuit 130. The optical identification tag 100 may further include a sensor 140.

The solar cell 110 converts input optical energy into electrical energy. The converted electrical energy is used for operations of the optical identification tag 100. Accordingly, the optical identification tag 100 is operated by not electrical energy supplied from a battery or the like but electrical energy supplied from the solar cell 110. To detail this, the solar cell 110 provides a current corresponding to incident light to the optical identification tag 100. Light input to the solar cell 110 may include information transmitted from an optical identification reader 200. In this case, the solar cell 110 delivers a received electrical signal corresponding to the information to the identification circuit 130. For example, a complementary metal oxide semiconductor (CMOS) solar cell may be employed as the solar cell 110. An example of the CMOS solar cell is disclosed in “IEICE Electronics Express, Vol. 3, No. 13, 287-291, On-chip solar battery structure for CMOS LSI, Yutaka ARIMA and Masaya EHARA.”

The light emitter 120 outputs an optical signal corresponding to the electrical signal delivered from the identification circuit 130. The wavelength of the light emitted from the light emitter 120 may be equal to or may not be equal to the wavelength of the light incident on the solar cell 110. When the wavelength of the light emitted from the light emitter 120 is not equal to the wavelength of the light incident on the solar cell 110 from the optical identification reader 200, the optical identification reader 200 may more accurately measure the light emitted from the light emitter 120. To detail this, when the optical identification reader 200 measures the light emitted from the light emitter 120, light provided to the solar cell 110 acts as background noises. Accordingly, when the wavelength of the light emitted from the light emitter 120 is different from the wavelength of the light provided to the solar cell 110, the optical identification reader 200 may remove the light provided to the solar cell 110 using a filter or the like to more accurately measure the light emitted from the light emitter 120. The light emitter 120 may be variously implemented. For example, the light emitter 120 may be implemented as an emissive element. An example of the emissive element may include a light emitting diode, an organic light emitting diode, a laser diode, and so forth. An example of the emissive element may be a transistor which emits ultraviolet light scattered due to hot electron scattering. Alternatively, the light emitter 120 may be implemented as a reflecting element. The reflecting element may be, for example, a micro-mirror which reflects or does not reflect light according to an electrical signal. Alternatively, the reflecting element may be a micro-mirror which changes a reflecting angle of light according to an electrical signal. Alternatively, the reflecting element may be a combination of the micro-mirror and a filter for transmitting or blocking light incident on the micro-mirror and/or light reflected to the micro-mirror according to an electrical signal. Any other element may be implemented as the light emitter 120 so long as the light emitter 120 may change light according to an electrical signal.

The identification circuit 130 operates using electrical energy provided from the solar cell 110, and delivers an electrical signal corresponding to the identification information to the light emitter 120. The identification circuit 130 has an identification information storage 131. An example of the identification information storage 131 may be a memory.

An object to be measured by the sensor 140 may be changed according to an application of the optical identification tag 100, and examples of the object may be temperature, light, pressure, magnetism, accelerating speed, PH, or molecular binding (e.g., binding of antigen and antibody). A structure of the sensor 140 may also be changed according to an application of the optical identification tag 100. For example, the sensor 140 may be a nanowire transistor, a nano particle, a fine film, or a fine beam sensor. A sense signal output from the sensor 140 is input to the identification circuit 130. The sense signal may include information output from the optical identification reader 200. For example, the optical identification reader 200 may carry the information on light and transmit it to the optical sensor 140, and the sensor 140 may deliver a sense signal corresponding to the information carried on the light to the identification circuit 130 (since the sense signal includes the information from the optical identification reader 200, it is also referred to as a received signal herein). When the optical identification tag 100 further includes the sensor 140, the identification circuit 130 may deliver electrical signals corresponding to the identification information and the sense signal to the light emitter 120.

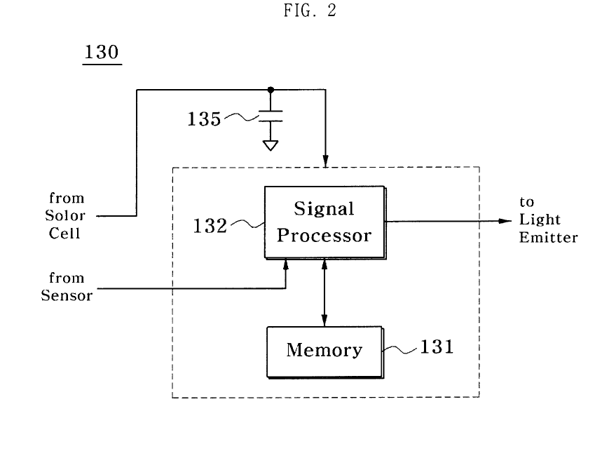

FIG. 2 illustrates an example of an identification circuit 130 employed in the optical identification tag of FIG. 1.

Referring to FIG. 2, the identification circuit 130 has an identification information storage 131 and a signal processor 132. The identification information storage 131 acts to store the identification information or the like. An example of the identification information storage 131 may be a static random access memory (SRAM). The signal processor 132 delivers an electrical signal corresponding to the identification information stored in the identification information storage 131 to the light emitter 120. When the optical identification tag 100 further includes the sensor 140, the identification circuit 130 may further deliver an electrical signal corresponding to a sense signal output from the sensor 140 to the light emitter 120. The sense signal may be a received signal including information transmitted to the optical identification tag 100 through light by the optical identification reader 200. In this case, the signal processor 132 may process the received signal delivered from the sensor 140. Processing of the received signal delivered from the sensor 140 using the signal processor 132 may be carried out in various manners similar to the processing of the received signal included in an output of the solar cell 110 using the signal processor 132 which will be described later. The signal processor 132 may be implemented using a simple microprocessor. Electrical energy required for operations of the identification information storage 131 and the signal processor 132 is delivered from the solar cell 110.

The identification circuit 130 may further include a capacitor 135. In this case, electric charges are charged in the capacitor 135 while light is incident on the solar cell 110, so that the identification information storage 131 and the signal processor 132 may operate for a predetermined period using the electric charges charged in the capacitor even after the light is not incident on the solar cell 110. However, the capacitor 135 occupies a large area, so that it is preferable not to employ the capacitor 135 when the optical identification tag needs to be integrated in a smaller way.

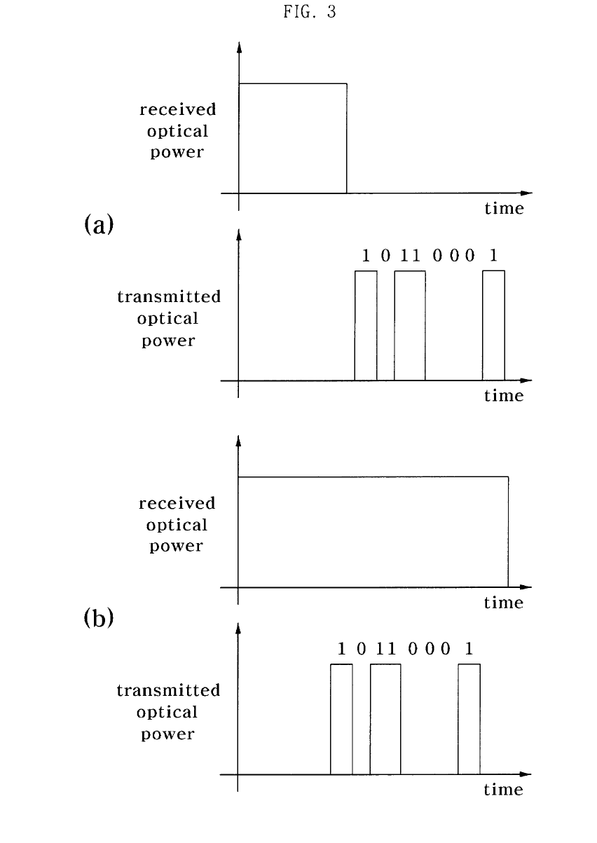

FIG. 3 illustrates examples of received and transmitted optical powers of the optical identification tag 100 in which the identification circuit 130 of FIG. 2 is employed.

(a) of FIG. 3 illustrates that a period for which the optical identification tag 100 receives light and a period for which the optical identification tag 100 transmits light are divided. Since the optical identification tag 100 does not receive light during the period of transmitting light, the light emitter 120 must be implemented using an emissive element, and the identification circuit 130 must have the capacitor 135.

(b) of FIG. 3 illustrates that the optical identification tag 100 transmits light within a period for which the optical identification tag 100 receives light. Since light is received during the period that the optical identification tag 100 transmits light, the light emitter 120 may be implemented using an emissive element or a reflecting element. In addition, the identification circuit 130 may not have the capacitor 135.

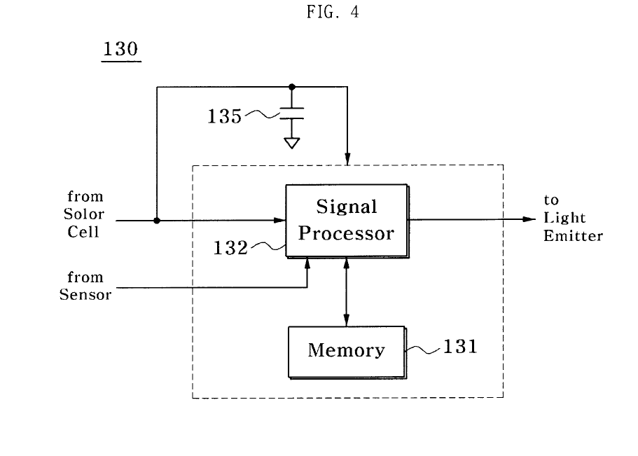

FIG. 4 illustrates another example of the identification circuit 130 employed in the optical identification tag of FIG. 1. Referring to FIG. 4, the identification circuit 130 has an identification information storage 131 and a signal processor 132. For example, the identification information storage 131 may have a memory, and the signal processor 132 may have a microprocessor.

The identification information storage 131 acts to store identification information or the like. The signal processor 132 delivers an electrical signal corresponding to the identification information stored in the identification information storage 131 to the light emitter 120. In addition, the signal processor 132 acts to process a received signal included in an output of the solar cell 110. For example, the signal processor 132 determines whether the received signal matches predetermined information stored in the identification information storage 131, and delivers an electrical signal corresponding to the identification information to the light emitter 120 only when the received signal matches the predetermined information. Alternatively, the signal processor 132 changes the identification information stored in the identification information storage 131 according to the received signal. As yet another example, the signal processor 132 delivers a transmitted electrical signal generated according to the identification information and the information corresponding to the received signal to the light emitter 120. The signal processor 132 may be implemented using a microprocessor.

When the optical identification tag 100 further includes the sensor 140, the identification circuit 130 may further deliver an electrical signal corresponding to the sense signal output from the sensor 140 to the light emitter 120. In addition, the sense signal may be a received signal. To detail this, light incident on the optical identification tag 100 includes information transmitted by the optical identification reader 200, and the optical sensor (e.g., a photodiode) may output a received electrical signal corresponding to the information to the identification circuit 130. In this case, the signal processor 132 processes the received signal delivered from the sensor 140. Processing of the received signal delivered from the sensor 140 using the signal processor 132 may be carried out in various manners similar to the processing of the received signal included in an output of the solar cell 110 using the signal processor 132 as described above.

The identification circuit 130 may further include a capacitor 135. In this case, the capacitor 135 is charged while light is incident on the solar cell 110, the identification information storage 131 and the signal processor 132 may operate for a predetermined period using the electric charges charged in the capacitor 135 even after light is not incident on the solar cell 110.

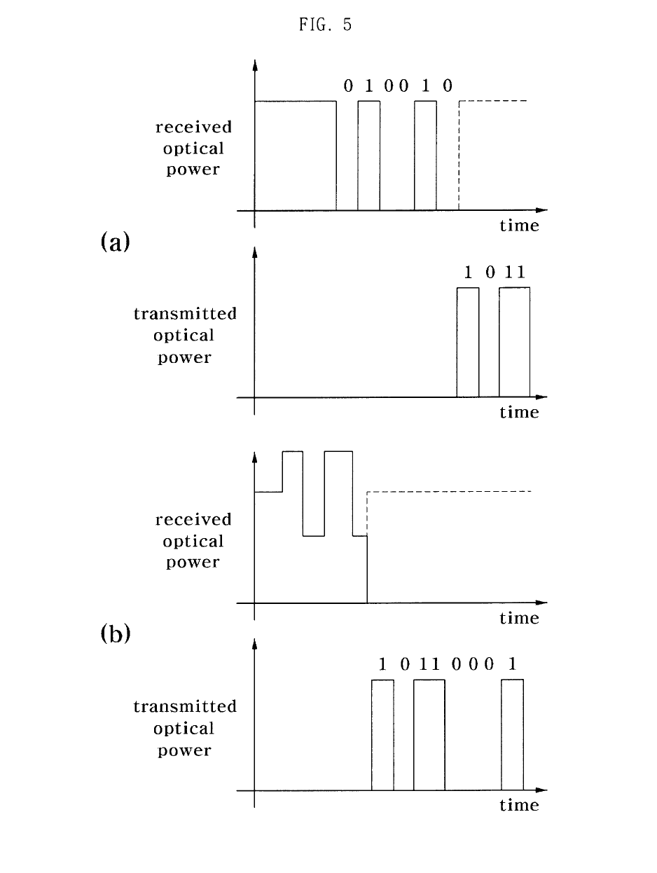

FIG. 5 illustrates examples of received and transmitted optical powers of the optical identification tag 100 in which the identification circuit 130 of FIG. 4 is employed.

(a) of FIG. 5 illustrates that a period for which the optical identification tag 100 mainly receives optical energy, a period for which the optical identification tag 100 mainly receives an optical signal, and a period for which the optical identification tag 100 mainly transmits light are divided. The optical identification tag 100 may receive the optical energy (dotted line) or may not receive the optical energy (solid line) during the period of light transmitted by the optical identification tag 100.

(b) of FIG. 5 illustrates that a period for which the optical identification tag 100 receives light and a period for which the optical identification tag 100 transmits light are divided. The optical identification tag 100 may receive the optical energy (dotted line) or may not receive the optical energy (solid line) while the optical identification tag 100 transmits light.

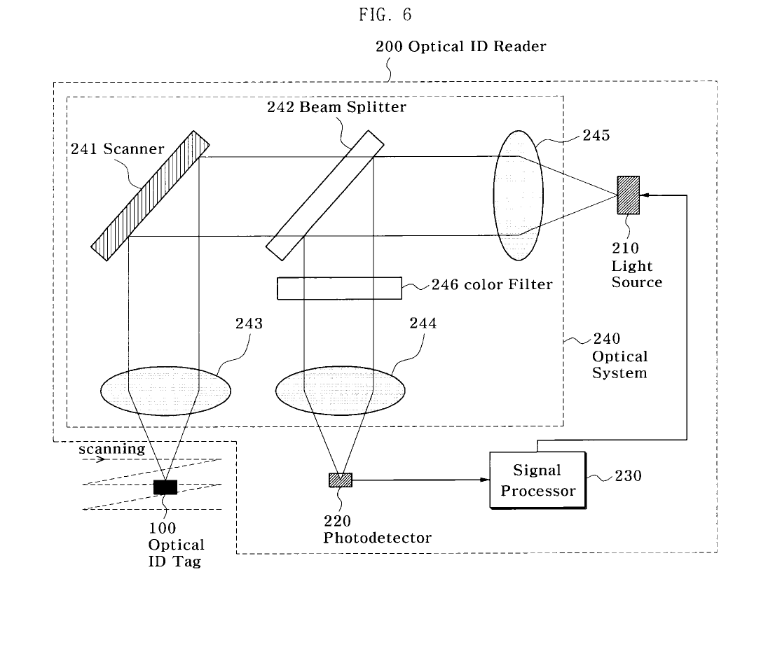

FIG. 6 illustrates an optical identification system having the optical identification tag of FIG. 1. Referring to FIG. 6, the optical identification system includes an optical identification tag 100 and an optical identification reader 200. The optical identification reader 200 includes a light source 210, a photodetector 220, a signal processor 230, and an optical system 240.

The light source 210 acts to supply light for the optical identification tag 100. Examples of the light source 210 may include a light emitting diode, a laser diode, or other proper light emitting elements. Powers of light output from the light source 210 may be changed according to the time as the received optical powers of FIGS. 3 and 5. The light power output from the light source 210 may be controlled by the signal processor 230.

The photodetector 220 acts to convert an optical signal transmitted from the optical identification tag 200 into an electrical signal. For example, the photodetector 220 may be a photodiode.

The signal processor 230 processes the electrical signal output from the photodetector 220 (e.g., performs amplification, analog-digital conversion, and so forth) to obtain a signal corresponding to the identification information of the optical identification tag 200. When powers of light output from the light source 210 are changed (e.g., an upper diagram of (a) of FIG. 3, an upper diagram of (b) of FIG. 3, an upper diagram of (a) of FIG. 5, and an upper diagram of (b) of FIG. 5), the signal processor 230 controls the light powers output from the light source 210.

The optical system 240 delivers light output from the light source 210 to the optical identification tag 100, and delivers the optical signal output from the optical identification tag 100 to the photodetector 220. To this end, the optical system 240 may include a scanner 241, a beam splitter 242, first to third lenses 243, 244, 245, and a color filter 246. The scanner 241 scans light provided through the beam splitter 242 from the light source 210 onto objects with the optical identification tag 100 (e.g., valuables). The scanner 241 may repeatedly operate such that it carries out scanning on one row and then carries out scanning again on the next row as represented in the diagram. The beam splitter 242 delivers light provided from the light source 210 to the optical identification tag 100 through the scanner 241, and delivers an optical signal provided through the scanner 241 from the optical identification tag 100 to the photodetector 220. For example, the beam splitter 242 may be a half mirror. The lenses 243, 244, 245 may be disposed between the optical identification tag 100 and the scanner 241, between the photodetector 220 and the beam splitter 242 and between the light source 210 and the beam splitter 242, respectively. When the wavelength of light provided from the light source 210 is different from the wavelength of light output from the optical identification tag 100, the optical system 240 may have the color filter 246 to prevent the light provided from the light source 210 from being reflected or scattered toward the photodetector 220. The color filter 246 blocks light having the same wavelength as the light provided from the light source 210, and transmits light having the same wavelength as the light output from the optical identification tag 100.

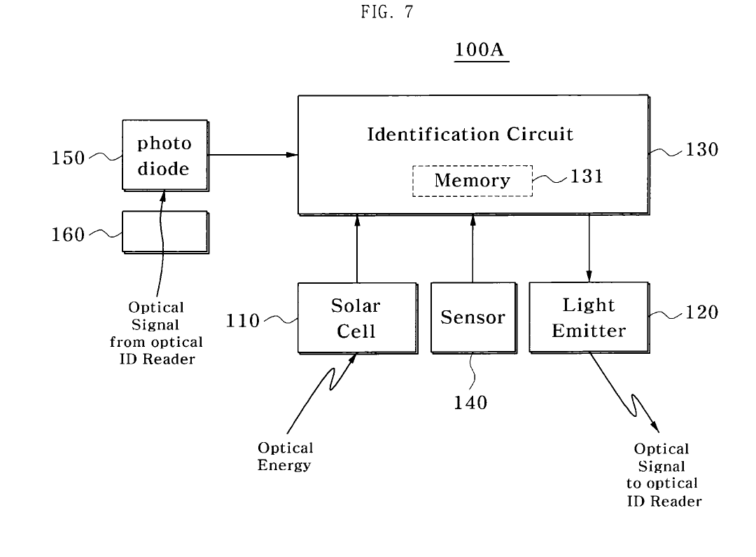

FIG. 7 illustrates an optical identification tag according to a second exemplary embodiment of the present invention. Referring to FIG. 7, the optical identification tag 100A has a solar cell 110, a light emitter 120, an identification circuit 130, a photodiode 150, and a color filter 160. The optical identification tag 100A may further include a sensor 140.

The solar cell 110 converts input optical energy into electrical energy. The converted electrical energy is used for operations of the optical identification tag 100. Light provided to the solar cell 110 may be one provided from an optical identification reader 200A. In this case, light (not including a signal) provided to the solar cell 110 from the optical identification tag 200 preferably has a different frequency from light (including a signal) provided to the photodiode 150 from the optical identification tag 200. The light provided to the solar cell 110 may be one provided from the sun or indoor illumination.

The light emitter 120 outputs an optical signal corresponding to the electrical signal delivered from the identification circuit 130.

The identification circuit 130 operates using the electrical energy provided from the solar cell 110, and delivers the electrical signal corresponding to the identification information to the light emitter 120.

An object to be measured by the sensor 140 may be changed according to an application of the optical identification tag 100, and examples of the object may be temperature, light, pressure, magnetism, accelerating speed, PH, or molecular binding (e.g., binding of antigen and antibody).

The photodiode 150 provides a received signal corresponding to light with a predetermined wavelength provided from the optical identification reader 200A to the identification circuit 130. The received signal provided from the photodiode 150 is processed by the identification circuit 130.

The color filter 160 acts to provide light of a predetermined wavelength among incident light to the photodiode 150. The light provided to the solar cell 110 corresponds to noises in a situation of the photodiode 150, so that a received signal may be more accurately obtained when some or all of the light provided to the solar cell 110 among incident light is removed. In particular, when the capacitor 135 is not employed, the color filter 160 is more useful. To detail this, when the capacitor 135 is not employed, the optical identification tag 100A must receive energy through the solar cell 110 simultaneously while receiving a signal through the photodiode 150. In this case, when the energy and the signal are transmitted through light of the same frequency, noises of the signal increase. Accordingly, when light for transmitting the energy and light for transmitting the signal have different wavelengths from each other and the color filter 160 is employed, the energy and the signal with a low noise may be simultaneously received without using the capacitor.

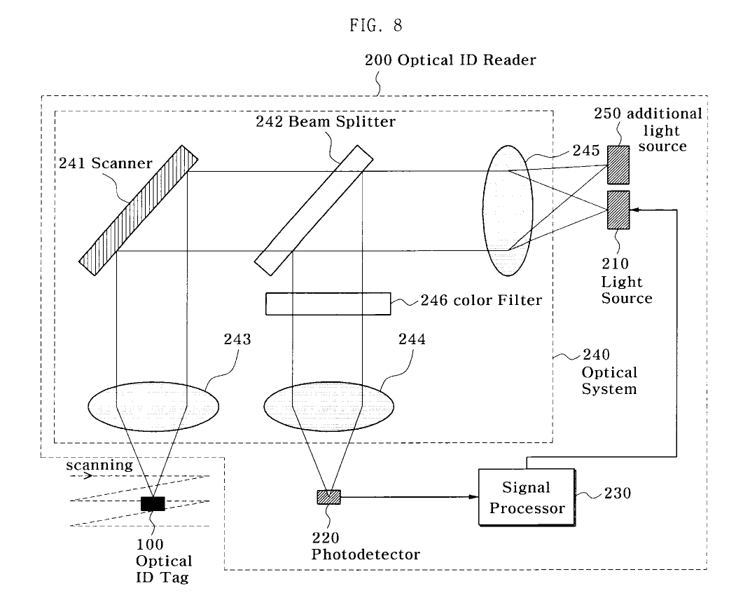

FIG. 8 illustrates an optical identification system having the optical identification tag 100A of FIG. 7. Referring to FIG. 8, the optical identification system has the optical identification tag 100A and the optical identification reader 200A. The optical identification reader 200A of FIG. 8 has an additional light source 250 in addition to the light source 210, the photodetector 220, the signal processor 230, and the optical system 240 included in the optical identification reader 200 of FIG. 6.

The light source 210 provides light having the power corresponding to the signal to be transmitted to the optical identification tag 100A by the optical identification reader 200A (e.g., an upper diagram of (a) of FIG. 3, an upper diagram of (b) of FIG. 3, an upper diagram of (a) of FIG. 5, and an upper diagram of (b) of FIG. 5).

The additional light source 250 acts to transmit the energy to the solar cell 110, and has a different wavelength from the light source 210. For example, the additional light source 250 provides light having a fixed power.

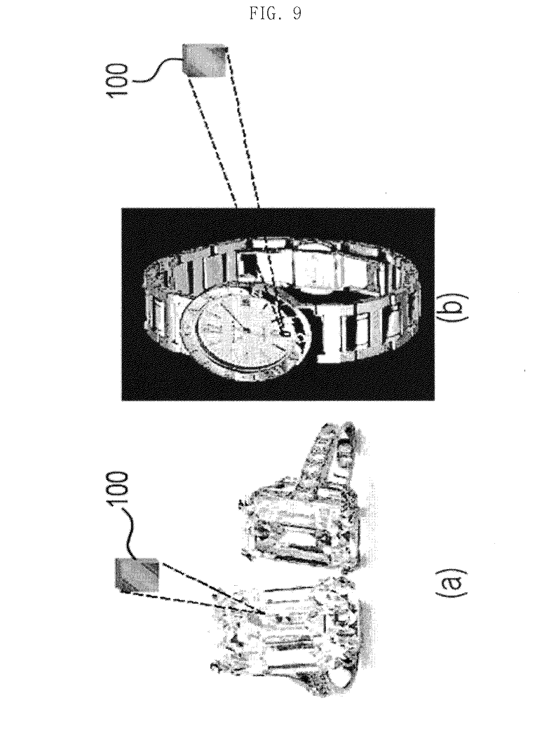

FIG. 9 illustrates that the optical identification tag 100 of the present invention is applied to jewelry. (a) of FIG. 9 illustrates the optical identification tag 100 attached to a ring, and (b) of FIG. 9 illustrates the optical identification tag 100 attached to a watch. As can be easily seen in FIG. 9, the optical identification tag 100 may be easily attached to the jewelry to deliver identification information of the jewelry to the optical identification reader.

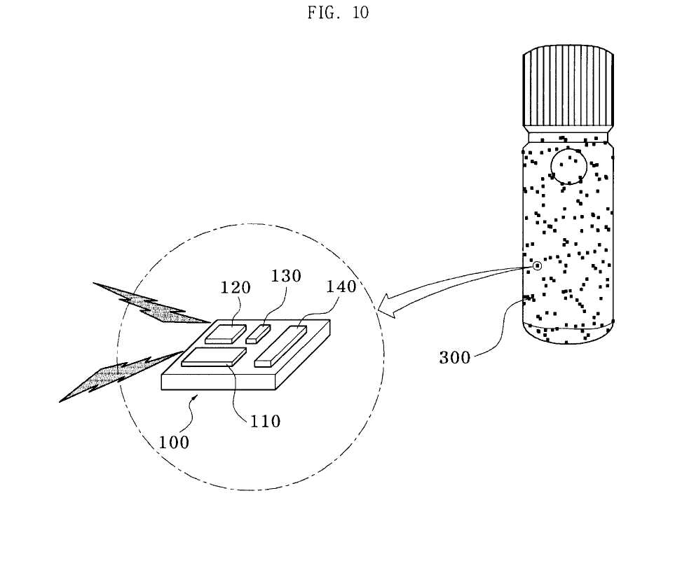

FIG. 10 illustrates the optical identification tag 100 of the present invention applied to a biological field. Referring to FIG. 10, liquids including molecules to be measured by the sensor 140 and a large amount of optical identification tags 100 are present within a test tube 300. The optical identification tags 100 may be manufactured to be very fine, so that several hundreds to several thousands of optical identification tags 100 may be present even in a small test tube.

The sensor 140 included in the optical identification tag 100 senses whether predetermined molecules (e.g., antigen) are bound with the sensor, and transmits the corresponding information outside through the light emitter 120.

The circuit 130 included in the optical identification tag 100 changes the identification information according to a received optical signal. For example, the identification information of the test tube 300 may be sequentially stored in a memory of the circuit 130 (for example, when liquids pass through test tubes A, B, C, identification information of the test tube A, the identification information of the test tube B, and the identification information of the test tube C are sequentially stored in the memory). Accordingly, when the identification information of the optical identification tag 100 is read by the optical identification reader 200, it can be found which test tube the optical identification tag 100 has passed through.

While the invention has been particularly shown and described with reference to exemplary embodiments thereof, it will be understood by those of ordinary skill in the art that various changes in form and details may be made therein without departing from the spirit and scope of the present invention as defined by the following claims.

1-26. (canceled)

27. An optical identification tag, comprising:
a solar cell for converting incident light into electrical energy, the electrical energy being used to operate an optical identification tag;
a circuit for providing an electrical identification signal corresponding to identification information; and
a light emitter for transmitting an optical signal corresponding to the electrical identification signal.

28. The optical identification tag according to claim 27, wherein the incident light and the optical signal have different wavelengths from each other.

29. The optical identification tag according to claim 27, wherein the circuit includes:
an identification information storage for storing the identification information; and
a signal processor for providing the electrical identification signal corresponding to the identification information.

30. The optical identification tag according to claim 27, wherein the solar cell converts a signal included in the incident light into a received electrical signal.

31. The optical identification tag according to claim 30, wherein the circuit includes:
an identification information storage for storing the identification information; and
a signal processor for processing the received signal and providing the electrical identification signal corresponding to the identification information.

32. The optical identification tag according to claim 27, further comprising:
a sensor connected to the circuit.

33. The optical identification tag according to claim 32, wherein the circuit includes:
an identification information storage for storing the identification information; and
a signal processor for providing the electrical identification signal corresponding to an output of the sensor and the identification information.

34. The optical identification tag according to claim 32, wherein the sensor is an optical sensor and converts a signal included in the incident light into a received electrical signal, and the circuit includes:
an identification information storage for storing the identification information; and
a signal processor for processing the received signal and providing the electrical identification signal corresponding to the identification information.

35. The optical identification tag according to claim 32, wherein the solar cell converts a signal included in the incident light into a received electrical signal, and the circuit includes:
an identification information storage for storing the identification information; and
a signal processor for processing the received signal and providing the electrical identification signal corresponding to an output of the sensor and the identification information.

36. The optical identification tag according to claim 27, wherein the circuit has a capacitor connected to an output terminal of the solar cell.

37. The optical identification tag according to claim 27, further comprising:
a color filter; and
a photodiode for providing a received signal corresponding to light selected by the color filer among the incident light to the circuit.

38. The optical identification tag according to claim 31, wherein processing the received signal by the signal processor includes changing the identification information stored in the identification information storage according to the received signal by the signal processor.

39. The optical identification tag according to claim 31, wherein processing the received signal by the signal processor includes providing the electrical identification signal corresponding to the received signal to the light emitter by the signal processor.

40. The optical identification tag according to claim 31, wherein processing the received signal by the signal processor includes determining by the signal processor whether the received signal matches predetermined information stored in the identification information storage and providing the electrical identification signal corresponding to the identification information to the light emitter only when the received signal matches the predetermined information.

41. An optical identification reader, comprising:
a light source for transmitting light to an optical identification tag;
a photodetector for converting received light provided from the optical identification tag into an electrical signal;
a signal processor for processing the electrical signal to obtain information corresponding to identification information of the optical identification tag; and
an optical system for delivering the transmitted light to the optical identification tag, and delivering light from the optical identification tag to the photodetector.

42. The optical identification reader according to claim 41, wherein the optical system includes:
a scanner for scanning the transmitted light onto an object associated with the optical identification tag; and
a beam splitter for delivering the transmitted light to the optical identification tag through the scanner, and delivering light from the optical identification tag through the scanner to the photodetector.

43. The optical identification reader according to claim 41, wherein the optical system includes a color filter, and the light from the optical identification tag is delivered to the photodetector through the color filter.

44. The optical identification reader according to claim 41, wherein the signal processor controls the light source to adjust power of the transmitted light.

45. The optical identification reader according to claim 44, further comprising:
an additional light source for providing additional light having a different wavelength from the transmitted light to the optical identification tag.

46. An optical identification system, comprising:
an optical identification tag for converting incident first light into an electrical energy, using the electrical energy to power optical identification tag operations, and outputting second light corresponding to stored identification information; and
an optical identification reader for converting the second light into an electrical signal.
